(19) United States
(12) Patent Application Publication
(10) Pub. No.: US 2015/0056529 A1
(43) Pub. Date: Feb. 26, 2015

(54) Forklift Fuel Cell Supply System

(71) Applicant: INFINTIUM FUEL CELL SYSTEMS (SHANGHAI) CO., LTD., Shanghai (CN)

(72) Inventor: Xuxu Ge, Shanghai (CN)

(21) Appl. No.: 14/364,512

(22) Filed: Jun. 11, 2014

Related U.S. Application Data
(63) Continuation of application No. PCT/CN2013/083379, filed on Sep. 12, 2013.

(30) Foreign Application Priority Data
Sep. 28, 2012 (CN) 201210367662

(51) Int. Cl. B66F 9/075; H01M 8/04; H01M 16/00; B60L 11/18

(52) U.S. Cl. CPC B66F 9/07572; B60L 11/1881; H01M 8/04298; H01M 16/006
USPC 429/428

(57) ABSTRACT

This invention provides an improved forklift fuel cell supply system consists of enclosure 90 and the fuel cell system 100, DCDC converting unit 2, contactor 3, energy storage device 4, controller 7 provided in the said enclosure 90, which also consists of the power supply output end 5 provided outside the said enclosure 90 and the operation control unit 6, electric isolation board 901, hydrogen storage system, filling valve 95 provided in the said enclosure 90, in which the said contactor 3 is a normal open type high-current contactor, the said DCDC converting unit 2 includes the DCDC converter 21 and high-power diode 22 connecting with it. This invention is compact in structure and facilitates such work as system installation, overhaul and maintenance, etc. This invention can contain an energy storage device with a higher capacity, making the energy storage device be in a charging and discharging condition with a low multiplying factor and extending the service life of the energy storage device and the time for which the system can be left unused.

### PRIORITY

The present invention claims priority to PCT patent application PCT/CN2013/083379, which has a filing date of Sep. 12, 2013. The present invention claims priority to Chinese patent application 201210367662, which has a filing date of Sep. 28, 2012.

### FIELD OF THE INVENTION

This invention relates to the new energy field, specifically to improved fuel cell supply system.

### BACKGROUND

When designing a forklift fuel cell system, in order to replace with the existing lead-acid battery directly to avoid forklift modification, all parts and components have to be centralized in a rectangular empty chamber. The forklift fuel cell system needs to include controller, energy storage device, DCDC converter, contactor, fuel cell system, hydrogen filling valve, hydrogen bottle, hydrogen system, etc. In order for the system to reach a weight equal to that of lead-acid battery, weights have to be placed. The parts and components required by the whole system are integrated in a narrow space, resulting in space being not available between parts and components. This may bring a very high trouble to installation, disassembly. Even when disassembling some parts and components, other parts and components have to be removed first.

The existing technology has a lot of disadvantages. Some design reduces system function; some design adopts an energy storage device with a small size and a small capacity, resulting in reduction in system performance; some design even has the hydrogen bottle be placed outside the system; some design provides almost no space for moving between parts and components in the system, as a result, when disassembling a part and component, other parts and components have to be removed; some design has no space in the system for the emergency stop button and relies on the emergency stop button designed for the hydrogen filling system, this may result in being unable to close the system quickly under an exceptional system emergency condition.

The technical scheme publicized by the utility model patent of China called “forklift gas bottle fixing device” with application number “200820233706.2” has the gas bottle be placed at the back end of a forklift, when using, it is necessary to change the hydrogen bottle, this also needs a lot of time. At the same time, placing a gas bottle at back of a forklift is very unsafe. Due to system being not compact, that scheme is unable to place the hydrogen bottle inside the system.

The Canadian patent called “FUEL CELL INDUSTRIAL VEHICLE” with publication number “CA2659135A1” provides a fuel cell forklift system scheme and redesigns the whole forklift. No direct replacement of the existing forklift cell can be made.

The utility model patent of China called “a new type of forklift” with application number “200920174236.1” provides a technical scheme which also considers redesign of existing vehicle.

The utility model patent of China called “a type of fuel cell forklift” with application number “200820179687.X” provides a technical scheme which also considers forklift redesign.

### SUMMARY

Aimed at the defects in existing technology, the said improved forklift fuel cell supply system solves the compact problem with the forklift fuel cell system. The forklift fuel cell has the whole system be placed in a rectangular empty chamber. Due to dimensional limitation, there is almost no space for moving between the parts and components. The line installation is troublesome. Disassembly of parts and components are troublesome with other parts and components having to be removed first. A space for weights is reserved.

The said improved forklift fuel cell supply system consists of enclosure and the fuel cell system, DCDC converting unit, contactor, energy storage device 4, controller 7 provided in the said enclosure 90, which also consists of the power supply output end 5 provided outside the said enclosure 90 and the operation control unit 6, electric isolation board 901, hydrogen storage system, filling valve 95 provided in the said enclosure 90, in which the said contactor 3 is a normal open type high-current contactor, the said DCDC converting unit 2 includes the DCDC converter 21 and high-power diode 22 connecting with it,

The said fuel cell system 100 connects the said DCDC converting unit 2, contactor 3, power supply output end 5, the said controller 7 connects the said fuel cell system 100, operation control unit 6, contactor 3, the said energy storage device 4 connects the said controller 7, operation control unit 6 and contactor 3,

The said electric isolation board 901 divides the space of the said enclosure 90 into electronic system space and gas supply space, the said fuel cell system 100, DCDC converting unit 2, contactor 3, energy storage device 4, controller 7, operation control unit 6, filling valve 95 are located in the said electronic system space, the said hydrogen storage system is located in the said gas supply space, the said gas supply space is located at the lower part of the said electronic system space.

Preferably, the said fuel cell system 100, energy storage device 4, DCDC converting unit 2 are installed in proper order on the electric isolation board 901 of the said enclosure 90 along the said enclosure 90 in a direction from front to back.

Preferably, the installing positions of both the said operation control unit 6 and controller 7 are higher than that of the said DCDC converting unit 2 and energy storage device 4.

Preferably, the said operation control unit 6 and controller 7 are installed in proper order along the said enclosure 90 in a direction from front to back.

Preferably, the said contactor 3 is installed in the area located between the side board of the said enclosure 90 and the said energy storage device 4 on the said base plate.

Preferably, the output end of fuel cell 1 that the said fuel cell system 100 contains connects the input end of the said DCDC converting unit 2, the DCDC converting unit 2 connects through the said contactor 3 the said energy storage device 4, the output end of the said DCDC converting unit 2 also connects the said power supply output end 5 and the high-power auxiliary component 80 that the said fuel cell system 100 contains, the port of the said energy storage device 4 connects through the said contactor 3 the said power supply output end 5 and the high-power auxiliary component 80 that the said fuel cell system 100 contained, the said operation control unit 6 connects respectively the said energy storage device 4, DCDC converting unit 2, controller 7, the said controller 7 connects respectively the fuel cell that the said fuel cell system 100 contains, the auxiliary system 8, the DCDC converting unit 2, the control end of the contactor 3, the energy storage device 4, in which the said auxiliary system 8 includes the said high-power auxiliary component 80,

The said operation control unit 6 is used to receive operation signals and supplies power for the said controller 7 and DCDC converting unit 2, the said controller 7 is used to receive the operation instructions generated by the said operation control unit 6 according to the said operation signals and controls according to the said operation instructions the said contactor 3, DCDC converting unit 2, auxiliary system 8, the said controller 7 is also used to measure the state parameters of the fuel cell 1 that the said fuel cell system 100 contains, measure the state parameters of the said energy storage device 4, measure the state parameters of the said auxiliary system and receive the state data of the said DCDC converting unit 2.

Preferably, the output end of the said fuel cell 1 connects the input end of the said DCDC converter 21, the positive pole of the output end of the said DCDC converter 21 connects the positive pole of the said high-power diode 22, the negative pole of the said high-power diode 22 connects through the said contactor 3 the said energy storage device 4, the said DCDC converter 21 connects the said controller 7 and is controlled by the said controller 7, the said DCDC converter 21 connects the said operation control unit 6 and receives the power supplied by the said operation control unit 6.

Preferably, the said operation control unit 6 changes the electric connection state with the said DCDC converting unit and controller 7 according to the startup operation signal received.

Preferably, the state data of the said DCDC converting unit 2 include DCDC input current, DCDC input voltage.

Preferably, any one or more following devices are also included:
The hydrogen safety system, the said hydrogen safety system include the sensors placed respectively in the electronic control system space and gas supply space, the said sensors connect the said controller 7,
The monitoring display 91, the said monitoring display 91 connect the said controller 7,
ON and OFF button 92, the said ON and OFF button 92 connects respectively the said operation control unit 6 and controller 7,
Remote control 93, the said remote control 93 connects in a radio mode the said operation control unit 6,
Emergency stop button 94, the said emergency stop button 94 connects the said operation control unit 6.

Comparing with the existing technology, the said improved forklift fuel cell supply system has the following beneficial effects:

1) The energy storage device placed by the existing technology in the system is small in capacity, making the energy storage device be in a charging and discharging condition with a high multiplying factor and reducing the service life of the energy storage device. The said improved forklift fuel cell supply system can contain an energy storage device with a higher capacity, making the energy storage device be in a charging and discharging condition with a low multiplying factor and extending the service life of the energy storage device and the time for which the system can be left unused. For example, in the circumstance that what is placed in the energy storage device is a lithium ion battery, the lithium ion battery placed as designed by the existing technology has a capacity 32AH, a peak output 48 KW. The lithium ion battery that can be placed in the said improved forklift fuel cell supply system has a capacity 50AH, a peak output 72 KW. When absorbing the forklift braking at 600A, the charging multiplying factor is 12C. That value in the existing technology is 18C. A higher energy storage device capacity reduces the charging and discharging multiplying factor at the same current output and favors extension of battery service life.

2) The said improved forklift fuel cell supply system is compact in structure and facilitates such work as system installation, overhaul and maintenance, etc.

3) In the enclosure, the operation control unit, controller are placed on the top. In the circumstance when they are not used by the system and moved outside forklift, inspection and maintenance, failure recovery can be made. The controller control software upgrading is also facilitated.

4) Spaces are reserved between parts and components, parts and components and enclosure, which facilitates line connection, part and component removal.

5) The compact structural design of the said improved forklift fuel cell supply system allows placing of the emergency stop button. In case of any emergency, the whole system can be disconnected quickly.

6) Such components as ON and OFF button, emergency stop button, filling valve, etc. required by system operation are placed at appropriate heights to facilitate filling, operation.

### BRIEF DESCRIPTION OF THE DRAWINGS

By reading and referring to the detailed descriptions made to the non-restrictive embodiment examples by the following attached figures, other characteristics, purposes and advantages of this invention will become more evident:

FIG. 1 is the schematic diagram of the general structure of an improved forklift fuel cell supply system;

FIG. 2 is the schematic diagram of the structure of the an improved fuel cell supply system according to this invention;

FIG. 3 is the specific structural schematic diagram of the DCDC converting unit in the improved fuel cell supply system as shown in FIG. 2;

FIG. 4 shows the schematic diagram of the high-power diode position in the improved fuel cell supply system of a preferable case of the first embodiment example provided according to this invention;

FIG. 5 is embodiment A of the improved forklift fuel cell supply system; and

FIG. 6 is embodiment B of the improved forklift fuel cell supply system.

### DETAILED DESCRIPTION

A detailed description to this invention is to be made below by combining with specific embodiment examples. The following embodiment examples will help the technical personnel in this field further understand this invention, but it does not limit this invention in any form. It should be pointed out that for ordinary technical people in this field, adjustments and changes can also be made under the prerequisite of not being divorced from the conceiving of this invention. All these belong to the protection scope of this invention.

The said improved forklift fuel cell supply system consists of enclosure 90 and the fuel cell system 100, DCDC converting unit 2, contactor 3, energy storage device 4, controller 7 provided in the said enclosure 90, which also consists of the power supply output end 5 provided outside the said enclosure 90 and the operation control unit 6, electric isolation board 901, hydrogen storage system, filling valve 95 provided the said enclosure 90. In which, the said contactor 3 is a normal open type high-current contactor, the said DCDC converting unit 2 includes the DCDC converter 21 and high-power diode 22 connecting with it,

The said fuel cell system 100 connects the said DCDC converting unit 2, contactor 3, power supply output end 5, the said controller 7 connects the said fuel cell system 100, operation control unit 6, contactor 3, the said energy storage device 4 connects the said controller 7, operation control unit 6 and contactor 3,

The said electric isolation board 901 divides the space of the said enclosure 90 into an electronic system space and a gas supply space, the said fuel cell system 100, DCDC converting unit 2, contactor 3, energy storage device 4, controller 7, operation control unit 6, filling valve 95 are located in the said electronic system space, the said hydrogen storage system is located in the said gas supply space, the said gas supply space is located at the lower part of the said electronic system space.

The said fuel cell system 100, energy storage device 4, DCDC converting unit 2 are provided in proper order on the electric isolation board 901 of the said enclosure 90 along the said enclosure 90 in a direction from front to back. The installing positions of both the said operation control unit 6 and controller 7 are higher than that of the said DCDC converting unit 2 and energy storage device 4. The said operation control unit 6 and controller 7 are installed in proper order along the said enclosure 90 in a direction from front to back. The said contactor 3 is installed in an area located between the side board of the said enclosure 90 and the said energy storage device 4 on the said base plate.

In a preferable case, the said forklift fuel cell supply system also consists of hydrogen safety system, monitoring display 91, ON and OFF button 92, remote control 93, emergency stop button 94, in which the said hydrogen safety system includes the sensors placed respectively in the electronic control system space and gas supply space, the said sensors connect the said controller 7, the said monitoring display 91 connects the said controller 7, the said ON and OFF button 92 connects respectively the said operation control unit 6 and controller 7, the said remote control 93 connects in a radio mode the said operation control unit 6 and the said emergency stop button 94 connects the said operation control unit 6.

The said fuel cell system 100 consists of fuel cell 1 and auxiliary system 8. The said auxiliary system 8 consists of air supply system, cooling system, hydrogen system, the said high-power auxiliary component 80 refers to a high-power component in the auxiliary system (for example, fan, pump, heat dissipation fan). The technical people in this field can refer to the existing technology to accomplish the said auxiliary system 8 and its high-power auxiliary component 80. No unnecessary detail is to be given here.

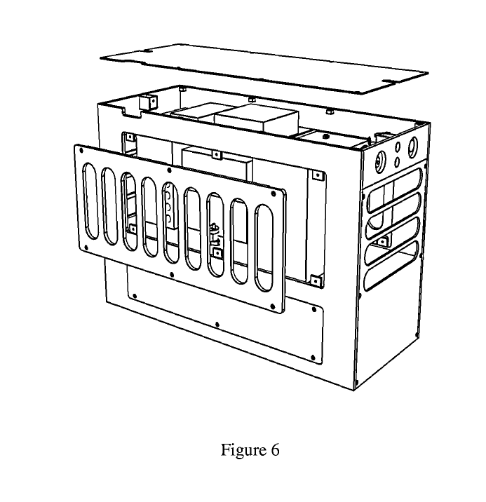

FIG. 5 and FIG. 6 show the fuel cell supply systems in the two embodiments of the said improved forklift fuel cell supply system. Specifically, FIG. 18 shows embodiment B-1: the 2-ton electric forklift from a forklift plant uses 48V lead-acid battery. That lead-acid battery is 1,210 mm long, 496 mm wide, 785 mm high, weighs 1,300 kg with a voltage 48V. The working voltage range of the forklift is 40-60V. The system is designed to have a length 1,210 mm, a width 500 mm, a height 780 mm and a weight 1,300 Kg, the rated voltage of the system is 40-60V. FIG. 19 shows embodiment B-2: the three-wheel standing steer and counterbalanced type forklift from a forklift plant using 36V lead-acid battery is 980 mm long, 520 mm wide, 787 mm high and weighs 1,180 kg. The working voltage range of the forklift is 30-45V. The system is designed to have a length 980 mm, a width 496 mm, a height 780 mm and a weight 1,180 Kg. The rated voltage of the system is 30-45V.

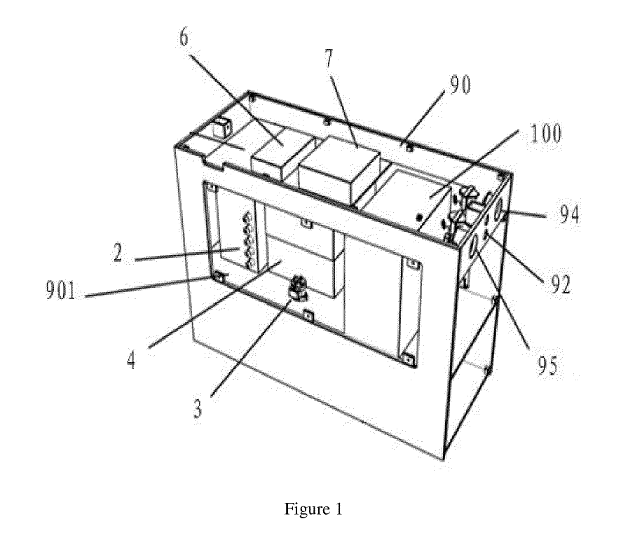

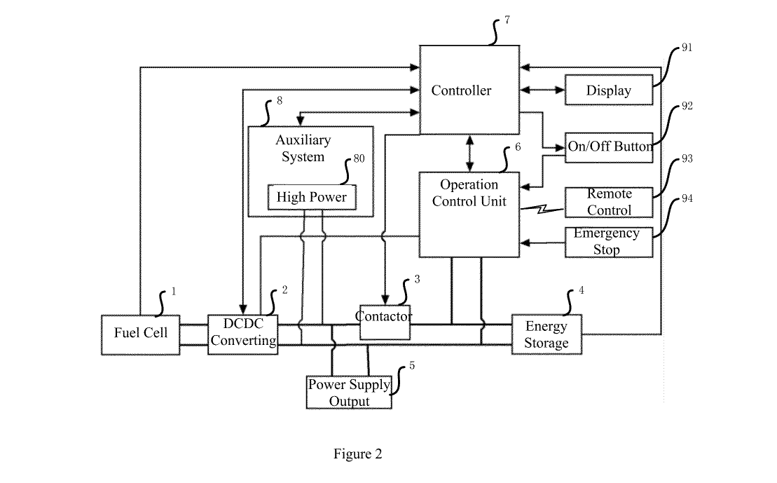

The reason that a compact structure as shown in FIG. 1 can be designed for the said forklift fuel cell supply system is mainly due to adopting the compact type fuel cell supply system as shown in FIG. 2.

FIG. 2 is the schematic diagram of the structure of the compact type fuel cell supply system of the first embodiment example provided according to this invention, in this embodiment example, the said compact type fuel cell supply system consists of fuel cell 1, DCDC converting unit 2, contactor 3, energy storage device 4, power supply output end 5, operation control unit 6, controller 7, auxiliary system 8, in which the said contactor 3 is a normal open type high-current contactor, the said DCDC converting unit 2 includes DCDC converter 21 and high-power diode 22 connecting with it.

Specifically, the output end of the said fuel cell 1 connects the input end of the said DCDC converting unit 2, DCDC converting unit 2 connects through the said contactor 3 the said energy storage device 4, the output end of the said DCDC converting unit 2 also connects the said power supply output end 5 and the high-power auxiliary component 80 that the said auxiliary system 8 contains, the port of the said energy storage device 4 connects through the said contactor 3 the said power supply output end 5 and auxiliary system 8, the said operation control unit 6 connects respectively the said energy storage device 4, DCDC converting unit 2, controller 7, the said controller 7 connects respectively the said fuel cell 1, DCDC converting unit 2, the control end of contactor 3, energy storage device 4 and auxiliary system 8.

In this embodiment example, the positive pole of the output end of the said DCDC converting unit 2 connects through the said contactor 3 the positive pole of the said energy storage device 4, the negative pole of the output end of the said DCDC converting unit 2 connects through the said contactor 3 the negative pole of the said energy storage device 4, the positive pole of the said energy storage device 4 connects through the said contactor 3 the positive pole of the said power supply output end 5 and the positive pole of auxiliary system 8, the negative pole of the said energy storage device 4 connects directly the negative pole of the said power supply output end 5 and the negative pole of auxiliary system 8; and in a variation of this embodiment example, the difference from the first embodiment example as shown in FIG. 1 is that in this variation, the change of the said contactor 3 in connecting position is: the said contactor 3 is connected between the negative pole of the output end of the said DCDC converting unit 2 and the negative pole of the said energy storage device 4, and the positive pole of the output end of the said DCDC converting unit 2 and the positive pole of the said energy storage device 4 are connected directly between them, correspondingly, the positive pole of the said energy storage device 4 connects directly the positive pole of the said power supply output end 5 and the positive pole of auxiliary system 8, the negative pole of the said energy storage device 4 connects through the said contactor 3 the negative pole of the said power supply output end 5 and the negative pole of auxiliary system 8. The technical people in this field understand that the two connection modes for contactor 3 as described in this natural paragraph can both realize “DCDC converting unit 2 connecting through the said contactor 3 the said energy storage device 4” and “the port of the said energy storage device 4 connecting through the said contactor 3 the said power supply output end 5 and auxiliary system 8”.

The said auxiliary system 8 consists of air supply system, cooling system, hydrogen system, hydrogen safety system, the said high-power auxiliary component 80 refers to a high-power component in the auxiliary system (for example, fan, pump, heat dissipation fan). The technical people in this field can refer to the existing technology to accomplish the said auxiliary system 8 and its high-power auxiliary component 80. No unnecessary detail is to be given here.

The said operation control unit 6 is used to receive operation signals and supplies power for the said controller 7 and DCDC converting unit 2, the said controller 7 is used to receive the operation instructions generated by the said operation control unit 6 according to the said operation signals and control according to the said operation instructions the said contactor 3, DCDC converting unit 2, auxiliary system 8, the said controller 7 is also used to measure the state parameters of the said fuel cell 1, measure the state parameters of the said energy storage device 4, measure the state parameters of the said auxiliary system 8 and receive the state data of the said DCDC converting unit 2. The said DCDC converter 21 consists of CAN communication module, input voltage measurement module, input current measurement module, output voltage measurement module, output current measurement module. Preferably, DCDC converter 21 can control according to the communication data of the CAN communication module the specific numerical values of the output current, voltage; also outputs through the CAN communication module such data as input voltage, input current, output voltage, output current, etc. The state data of the said DCDC converting unit 2 includes DCDC input current, DCDC input voltage.

The said controller 7 is a controller with an integrated design, which is equivalent to the scattered fuel cell controller, whole vehicle controller, battery energy management system in the invention patent application of China with patent application number “200610011555.1”; further specifically, the said controller 7 can consist of energy management unit, fuel cell control unit, energy storage device monitoring unit, hydrogen safety monitoring unit, system failure monitoring unit and startup control unit.

More specifically, as shown in FIG. 2, the output end of the said fuel cell 1 connects the input end of the said DCDC converter 21, the positive pole of the output end of the said DCDC converter 21 connects the positive pole of the said high-power diode 22, negative pole of the said high-power diode 22 connects through the said contactor 3 the said energy storage device 4, the said DCDC converter 21 connects the said controller 7 and is controlled by the said controller 7, the said DCDC converter 21 connects the said operation control unit 6 and receives the power supplied by the said operation control unit 6. And in a variation of this embodiment example, the difference from the first embodiment example as shown in FIG. 2 is that in this variation, the positive pole of the output end of the said fuel cell 1 connects the positive pole of the said high-power diode 22, the negative pole of the said high-power diode 22 connects the positive pole of the input end of the said DCDC converter 21, the negative pole of the output end of the said fuel cell 1 connects directly the negative pole of the input end of the said DCDC converter 21, the output end of the said DCDC converter 21 directly connects through the said contactor 3 the said energy storage device 4.

Further, in this embodiment example, the said compact type fuel cell supply system also consists of monitoring display 91, ON and OFF button 92, remote control 93, emergency stop button 94, in which the said monitoring display 91 connects the said controller 7, the said ON and OFF button 92 connects respectively the said operation control unit 6 and controller 7, the said remote control 93 connects in a radio mode the said operation control unit 6, the said emergency stop button 94 connects the said operation control unit 6. As shown in FIG. 1, when the said ON and OFF button 92 or remote control 93 gives a startup signal, the said operation control unit 6 supplies power to the said controller 7, the said controller 7 outputs a control signal to the contactor used as a switch to make it close, the said energy storage device 4 supplies power through the said contactor 3 to the said high-power auxiliary component 80, in the said auxiliary system 8, except the said high-power auxiliary component 80, other devices (for example, hydrogen system, hydrogen safety system) are supplied by the said controller 7, at the same time, the said controller 7 outputs signals to all modules constituting the said auxiliary system 8 to start the said fuel cell 1; after starting, the said contactor 3 maintains the state of connection at all times. By adopting this starting mode, it is not necessary to use additionally configured auxiliary battery and auxiliary DC/DC converter for charging, as a result, parts and components and corresponding lines are reduced, system reliability is improved, space is saved, system volume and costs are reduced.

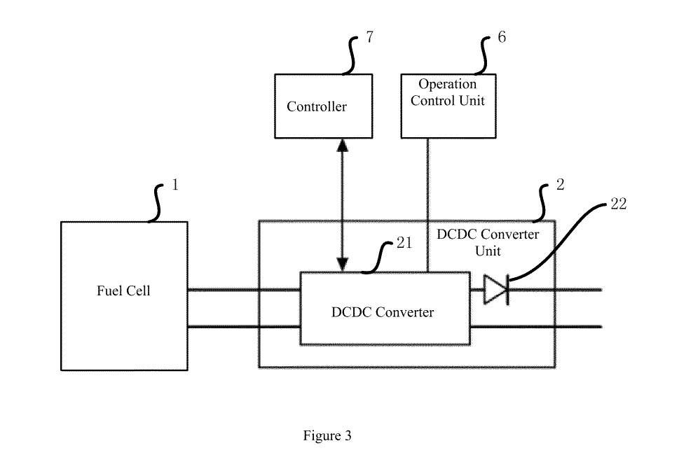

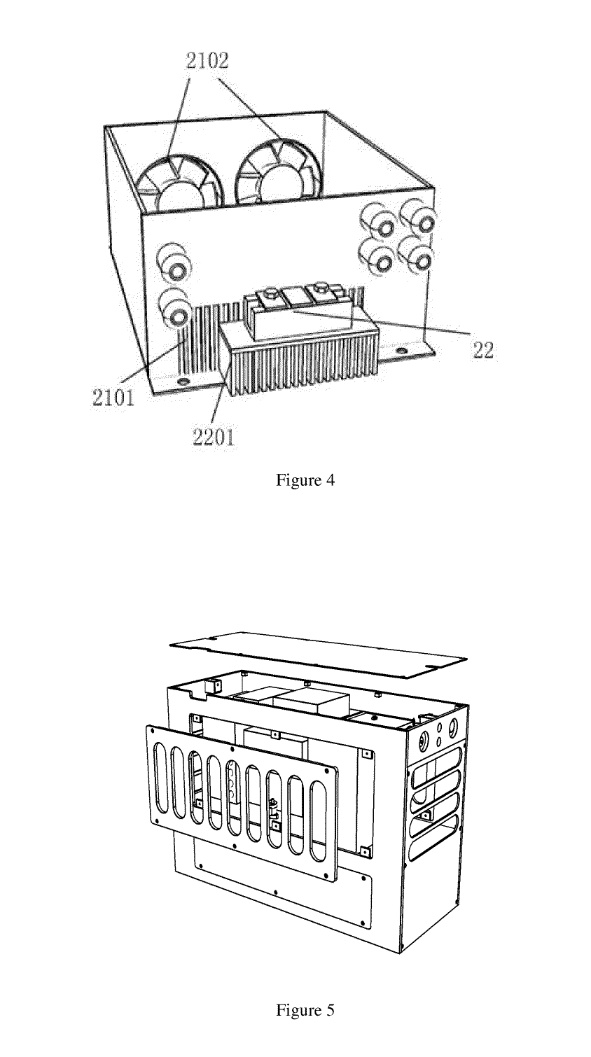

In a preferable case of this embodiment example, as shown in FIG. 3, the said high-power diode 22 is placed on the heat dissipation passage of the said DCDC converter 21, this can use the air discharged from the air duct 2101 by the heat dissipation fan 2102 contained by the said DCDC converter itself to dissipate heat from the said high-power diode 22, as a result, the heat dissipation fan on the heat dissipator 2201 (i.e. aluminum fin) for the said high-power diode is saved, the volume of heat dissipater is reduced, energy is saved, at the same time, the line to supply power to that heat dissipation fan is also saved. The said operation control unit 6 changes the electric connection state with the said DCDC converting unit and controller 7 according to the startup operation signal received. Thus, the said controller 7 is in an operation condition only when the system is working and will not lead to the problem of high system energy consumption due to being always in an operation condition.

Next, the system working principle is described through a preferable embodiment of this invention. Specifically, When the system is not started, the said operation control unit 6 and the said controller 7, DCDC converting unit 2 establish no electric connection state between them. When the button of the said remote control 93 or the said ON and OFF button 92 is depressed, the said operation control unit 6 and the said controller 7, DCDC converting unit 2 establish an electric connection between them, the said energy storage device 4 supplies power through the said operation control unit 6 to the said controller 7, the output signal of the said controller 7 drives the said contactor 3 to get connected, the said energy storage device 4 supplies power through the said contactor 3 to the said high-power auxiliary component 80, in the said auxiliary system 8, except the said high-power auxiliary component 80, other devices (for example, hydrogen system, hydrogen safety system) are supplied by the said controller 7, at the same time, the said controller 7 outputs working signals to all modules constituting the said auxiliary system 8 to start the said fuel cell 1; the said fuel cell 1 outputs power to the said DCDC converting unit 2, the said controller 7 controls according to the received state data signals of the said fuel cell 1, energy storage device 4, DCDC converting unit 2 the said DCDC converting unit 2 output current; under the normal system working condition, the output voltage of the said DCDC converting unit 2 is higher than the output voltage of the said energy storage device 4, the output current of the said DCDC converting unit 2 is output through the said power supply output end 5 to the small vehicle drive system carrying the said fuel cell supply system to drive the small vehicle to work, at the same time, the said DCDC converting unit 2 charges the said energy storage device 4, supplies power to the said high-power auxiliary component 80, operation control unit 6; when a small vehicle is in a high-power driving condition, the said power supply output end 5 needs to output high power, high currency, at this time, the said DCDC converting unit 2 output current is not sufficient to satisfy the requirements, the said energy storage device 4 will output current together with the said DCDC converting unit 2 to the small vehicle driving system carrying that fuel cell supply system through the said power supply output end 5 to drive that small vehicle to maintain the high-power driving condition; when the small vehicle is in a braking condition, the power energy recovered by the brake charges through the power supply output end the energy storage device.

When it is necessary to start the system, just depress the button of the said remote control 93 or the said ON and OFF button 92, in the meantime that the said operation control unit 6 and the said controller 7, DCDC converting unit 2 establish an electric connection, the said operation control unit 6 outputs a switch signal to the said controller 7, the said controller 7, after receiving the switch signal, outputs a signal to maintain power supply to the said operation control unit 6, so that the said operation control unit 6 and the said controller 7, DCDC converting unit 2 maintain an electric connection state; at the same time, the said controller 7 also drives the indicator light of the said ON and OFF button 92 to become on to prompt system starting; at this time, the button of the said remote control 93 or the said ON and OFF button 92 can be released.

When it is necessary to close the system, depress again the button of the said remote control 93 or the said ON and OFF button 92, the said operation control unit 6 outputs a switch signal to the said controller 7, the said controller 7, after receiving the switch signal, controls the indicator light of the said ON and OFF button 92 to blink (prompting switching off, at this time, the button of the said remote control 93 or the said ON and OFF button 92 can be released), the said controller 7 simultaneously controls the said auxiliary system 8 to stop working, and then stops outputting the signal to maintain power supply to the said operation control unit 6, so that the electric connection of the said operation control unit 7 and the said controller 7, DCDC converting unit 2 is disconnected; the whole system stops working.

When the said emergency stop button 94 is depressed, the electric connection between the said operation control unit 6 and the said controller 7, DCDC converting unit 2 get disconnected quickly to cut off the power supply to the whole system and make the system stop working.

The said monitoring display 91 gets power, communication data from the said controller 7, displays the system condition, failure information, etc. on the screen.

The embodiment examples of this invention are described above. What needs understanding is that that this invention is not limited to above specific embodiments. The technical people in this field can make various variations or modifications with the Claim, and this does not influence the essential contents of this invention.

1. An improved forklift fuel cell supply system consists of enclosure 90 and the fuel cell system 100, DCDC converting unit 2, contactor 3, energy storage device 4, controller 7 provided in the said enclosure 90, which also consists of the power supply output end 5 provided outside the said enclosure 90 and the operation control unit 6, electric isolation board 901, hydrogen storage system, filling valve 95 provided in the said enclosure 90, in which the said contactor 3 is a normal open type high-current contactor, the said DCDC converting unit 2 includes the DCDC converter 21 and high-power diode 22 connecting with it,
The said fuel cell system 100 connects the said DCDC converting unit 2, contactor 3, power supply output end 5, the said controller 7 connects the said fuel cell system 100, operation control unit 6, contactor 3, the said energy storage device 4 connects the said controller 7, operation control unit 6 and contactor 3,
The said electric isolation board 901 divides the space of the said enclosure 90 into electronic system space and gas supply space, the said fuel cell system 100, DCDC converting unit 2, contactor 3, energy storage device 4, controller 7, operation control unit 6, filling valve 95 are located in the said electronic system space, the said hydrogen storage system is located in the said gas supply space, the said gas supply space is located at the lower part of the said electronic system space.

2. According to claim 1, the said fuel cell system 100, energy storage device 4, DCDC converting unit 2 are installed in proper order on the electric isolation board 901 of the said enclosure 90 along the said enclosure 90 in a direction from front to back.

3. According to claim 1, the installing positions of both the said operation control unit 6 and controller 7 are higher than that of the said DCDC converting unit 2 and energy storage device 4.

4. According to claim 1, the said operation control unit 6 and controller 7 are installed in proper order along the said enclosure 90 in a direction from front to back.

5. According to claim 1, the said contactor 3 is installed in the area located between the side board of the said enclosure 90 and the said energy storage device 4 on the said base plate.

6. According to claim 1, the output end of fuel cell 1 that the said fuel cell system 100 contains connects the input end of the said DCDC converting unit 2, the DCDC converting unit 2 connects through the said contactor 3 the said energy storage device 4, the output end of the said DCDC converting unit 2 also connects the said power supply output end 5 and the high-power auxiliary component 80 that the said fuel cell system 100 contains, the port of the said energy storage device 4 connects through the said contactor 3 the said power supply output end 5 and the high-power auxiliary component 80 that the said fuel cell system 100 contained, the said operation control unit 6 connects respectively the said energy storage device 4, DCDC converting unit 2, controller 7, the said controller 7 connects respectively the fuel cell that the said fuel cell system 100 contains, the auxiliary system 8, the DCDC converting unit 2, the control end of the contactor 3, the energy storage device 4, in which the said auxiliary system 8 includes the said high-power auxiliary component 80,
The said operation control unit 6 is used to receive operation signals and supplies power for the said controller 7 and DCDC converting unit 2, the said controller 7 is used to receive the operation instructions generated by the said operation control unit 6 according to the said operation signals and controls according to the said operation instructions the said contactor 3, DCDC converting unit 2, auxiliary system 8, the said controller 7 is also used to measure the state parameters of the fuel cell 1 that the said fuel cell system 100 contains, measure the state parameters of the said energy storage device 4, measure the state parameters of the said auxiliary system and receive the state data of the said DCDC converting unit 2.

7. According to claim 1, the output end of the said fuel cell 1 connects the input end of the said DCDC converter 21, the positive pole of the output end of the said DCDC converter 21 connects the positive pole of the said high-power diode 22, the negative pole of the said high-power diode 22 connects through the said contactor 3 the said energy storage device 4, the said DCDC converter 21 connects the said controller 7 and is controlled by the said controller 7, the said DCDC converter 21 connects the said operation control unit 6 and receives the power supplied by the said operation control unit 6.

8. According to claim 1, the said operation control unit 6 changes the electric connection state with the said DCDC converting unit and controller 7 according to the startup operation signal received.

9. According to claim 1, the state data of the said DCDC converting unit 2 include DCDC input current, DCDC input voltage.

10. According to claim 1, any one or more following devices are also included:
The hydrogen safety system, the said hydrogen safety system include the sensors placed respectively in the electronic control system space and gas supply space, the said sensors connect the said controller 7,
The monitoring display 91, the said monitoring display 91 connect the said controller 7,
ON and OFF button 92, the said ON and OFF button 92 connects respectively the said operation control unit 6 and controller 7,
Remote control 93, the said remote control 93 connects in a radio mode the said operation control unit 6,
Emergency stop button 94, the said emergency stop button 94 connects the said operation control unit 6.

11. A forklift fuel cell supply system comprising:
a fuel cell system, an energy storage device, and an open type high-current contactor;
a DCDC converting unit further comprising a DCDC converter and a high-power diode;
said fuel cell system, said energy storage device, and said contactor disposed in an enclosure, said enclosure further comprising a power supply output end disposed outside said enclosure;
a controller, operation control unit, electric isolation board, hydrogen storage system, and filling valve disposed within said enclosure;
said controller in communication with said fuel cell system, an operation control unit, and said contactor;
said energy storage device in communication with said controller, said operation control unit and said contactor;
said fuel cell system in communication with said DCDC converting unit, said contactor, and said power supply output end;
said electric isolation board divides the space of the said enclosure into an electronic system space and a gas supply space, said gas supply space being disposed at the lower part of said electronic system space;
said fuel cell system, said DCDC converting unit, said contactor, said energy storage device, said controller, said operation control unit, and said filling valve are disposed in the said electronic system space; and
said hydrogen storage system is located in the said gas supply space.

12. The system of claim 11, wherein said fuel cell system, energy storage device, and said DCDC converting unit are installed in operational order on the electric isolation board of said enclosure longitudinally along said enclosure from front to back.

13. The system of claim 11, wherein the relative positions of said operation control unit and said controller are higher than that of said DCDC converting unit and energy storage device.

14. The system of claim 11, wherein said operation control unit and said controller are installed in operational order along said enclosure longitudinally from front to back.

15. The system of claim 11, wherein said contactor is disposed in the area located between the side board of said enclosure and said energy storage device on the base plate.

16. The system of claim 11, wherein the output end of fuel cell of said fuel cell system is in communication with the input end of said DCDC converting unit, said DCDC converting unit connects through said contactor to said energy storage device 4, an output end of said DCDC converting unit also connects said power supply output end and a high-power auxiliary component of said fuel cell system, a port of said energy storage device connects through said contactor to said power supply output end and said high-power auxiliary component of said fuel cell system, said operation control unit connects said energy storage device, said DCDC converting unit, said controller;
said controller connects to said fuel cell of said fuel cell system, the auxiliary system, said DCDC converting unit, the control end of said contactor, said energy storage device, in which the said auxiliary system 8 includes a high-power auxiliary component 80;
said operation control unit receives operation signals and supplies power for said controller and DCDC converting unit, said controller receives the operation instructions generated by said operation control unit according to said operation signals and controls according to said operation instructions said contactor, DCDC converting unit, auxiliary system;
said controller is configured to measure the state parameters of the fuel cell, measure the state parameters of said energy storage device, measure the state parameters of the said auxiliary system and receive the state data of the said DCDC converting unit.

17. The system of claim 11, wherein the output end of said fuel cell connects the input end of said DCDC converter, the positive pole of the output end of said DCDC converter connects the positive pole of said high-power diode, the negative pole of said high-power diode connects through the said contactor to said energy storage device, said DCDC converter connects said controller and is controlled by the said controller, said DCDC converter connects said operation control unit and receives the power supplied by said operation control unit.

18. The system of claim 11, wherein said operation control unit changes the electric connection state with said DCDC converting unit and controller according to the startup operation signals received.

19. The system of claim 11, wherein the state data of said DCDC converting unit includes DCDC input current and DCDC input voltage.

20. The system of claim 11, further comprising at least one of the following devices:
a hydrogen safety system including sensors disposed within the electronic control system space and gas supply space, said sensors in communication with said controller;
a monitoring display in communication with said controller, and having an ON/OFF button connecting said operation control unit and controller;
a remote control in radio frequency communication with said operation control unit 6;
an emergency stop button in communication with said operation control unit.
